(19) United States
(12) Patent Application Publication
(10) Pub. No.: US 2014/0123513 A1
(43) Pub. Date: May 8, 2014

(54) Musical instrument drying, ventilation and storage case with activated charcoal filter

(71) Applicant: Jeffrey Alan Ciffin, Okemos, MI (US)

(72) Inventor: Jeffrey Alan Ciffin, Okemos, MI (US)

(21) Appl. No.: 13/667,589

(22) Filed: Nov. 2, 2012

(51) Int. Cl. F26B 21/00; G10G 7/00

(52) U.S. Cl. CPC F26B 21/003; G10G 7/005
USPC 34/82

(57) ABSTRACT

Woodwind and Brass Instrument drying, ventilated carrying cases are disclosed. According to one embodiment the drying and ventilating case comprises a multiple fan and filter unit containing a fan mounted on the inside of the case configured for drawing outside air into the case, passing it through the instrument and forcing it back out of the case, a filter system for removing harmful gasses from the air passing through the case and instrument, an electrical energy source coupled to the case and fans via a removable cable, where moistures accumulated inside the instrument are desired to be removed by while in the storage case when the instrument is not in use.

### REFERENCES CITED

### Citations

| Cited Patent | Filing date | Issue date | Title |
|---|---|---|---|
| U.S. Pat. No. 1,421,529 | Sep. 30, 1921 | Jul. 4, 1922 | DEVICE |
| U.S. Pat. No. 2,759,714 | Jan. 11, 1954 | Aug. 1, 1956 | PORTABLE FAN |
| U.S. Pat. No. 3,488,790 | Feb. 26, 1968 | Jan. 13, 1970 | CLEANING ROD FOR WOODWIND |
| | | | MUSICAL INSTRUMENTS |
| U.S. Pat. No. 3,739,420 | Mar. 10, 1972 | 1973 | MARSHALL DANN |
| U.S. Pat. No. 4,114,504 | Jul. 25, 1977 | Sep. 19, 1978 | Demoisturizer for wind musical instruments |
| U.S. Pat. No. 5,060,336 | Jun. 18, 1990 | Oct. 29, 1991 | Device for cleaning wind musical |
| | | | Instruments |
| U.S. Pat. No. 5,212,332 | Jul. 15, 1991 | May 18, 1993 | Swab for wind instruments |
| U.S. Pat. No. 5,555,588 | Feb. 17, 1994 | Sep. 17, 1996 | Device for cleaning the interior of a wind |
| | | | Instrument |
| U.S. Pat. No. 5,839,204 | Aug. 13, 1997 | Nov. 24, 1998 | Portable dryer with a retractable handle |
| | | | pitting into an indented housing |
| U.S. Pat. No. 5,930,913 | Dec. 9, 1997 | Aug. 3, 1999 | Portable shoe dehumidifier |
| U.S. Pat. No. 6,005,179 | Jul. 17, 1998 | Dec. 21, 1999 | Woodwind cleaning sleeve |
| U.S. Pat. No. 6,732,449 | Apr. 9, 2003 | May 11, 2004 | Dryer/blower appliance with efficient waste |
| | | | heat dissipation |
| U.S. Pat. No. 7,795,522 | Jun. 22, 2009 | Sep. 14, 2010 | Moisture drying apparatus for wind musical |
| | | | Instruments |
| U.S. Pat. No. 7,941,888 | Feb. 6, 2008 | May 17, 2011 | Apparatus for cleaning a woodwind |
| | | | Instrument |
| US20090271945 | May 5, 2009 | | Air blower |
| U.S. Pat. No. 5,636,103 | Jun. 12, 1995 | Jun. 03, 1997 | portable air cooling apparatus for electronic |
| | | | equipment |
| U.S. Pat. No. 4,992,084 | Apr. 20, 1989 | Feb. 12, 1991 | Activated Charcoal filter layer for gas masks |
| U.S. Pat. No. 4,510,193 | May 20, 1983 | Apr. 09, 1985 | Filter Sheet Materials |

### FIELD OF INVENTION

The present invention relates to an improvement of a standard instrument storage case.

The musical instruments included in this filtered air flow drying case include but are not limited to Brass, Woodwind and Percussion instruments. For example: clarinet, trumpet, Flute, Saxophone, French Horn, Cornet, Tuba, Trombone, Xylophone, Cymbals, and Drums.

One aspect of the invention relates to the storage and protection of the musical instruments.

Another aspect relates to drying the instruments.

Another aspect involves ventilating the case while purifying the air around the instrument to reduce oxidation and tarnish of the musical instruments and their components.

### BACKGROUND OF INVENTION

It is known that all musical wind instruments collect saliva from the performer inside the instrument during normal play. As a result moisture is formed and accumulated inside the instrument and the standard storage case, thereby causing odor to the case and rust or corrosion to the instrument. To overcome this problem one of the prior art approaches is to swab the instrument to remove accumulated moistures. However, using a swab has a number of problems: 1. The swab can jam inside the instrument. 2. The swab cannot completely remove the moisture inside the instrument, nor can it reach all the crevasses inside the instrument. 3. The swab can damage the instrument's sensitive and aligned keys if used improperly.

Another prior art approach is to place a fan inside the cavity of the instruments. However, using a moisture drying devise inside the instrument: 1. may scratch the instrument. 2. Cannot be used inside a closed sealed case as the air pressure will not allow the air to move effectively through the instrument. 3. A storage case cannot be closed if the instrument drying devise power supply cord is hanging out of the case.

Further problem of accumulated moistures is a result of normal practice of storing musical instruments inside a standard sealed protective case after playing. Since the environment is sealed, moistures trapped cannot evaporate, thus increasing the problems of tarnish, corrosion within the instrument and odors in the case.

Therefore it would be desirable to have a moisture drying and ventilating storage case that overcomes the drawbacks and limitations and shortcomings of prior art approaches. Especially a storage case that would protect the instrument when not in use as well as dry the instrument and protect it from rust corrosion and odors.

This invention will dry the instrument and the protective fabric of the case, while in the storage case; thus reducing odors, rust and corrosion; and may be used with the storage case sealed thus protecting the instrument when not in use.

The invention also utilizes an activated charcoal filter over the intake fan and the exhaust fan to filter the air. This protects the instrument from tarnish. These activated charcoal filters may be changed periodically depending on use. This invention does not lay claim to the Charcoal filter itself.

### DETAILED DESCRIPTION OF INVENTION

Our filtration/ventilation method uses pieces of activated charcoal over the air-flow fans to remove contaminants and impurities, utilizing chemical adsorption. Each grain of charcoal is designed to provide a large section of surface area, in order to allow contaminants in the air the most possible exposure to charcoal. The activated charcoal filter or (tarnish paper) is also placed over the exhaust opening in the case to prevent unfiltered air flow back into the case when the fan is not in operation. The filter is made of a mesh material ranging from 50 to 200 microns and filled with activated charcoal and can be found in many standard water or air filtration systems. The micron size of the filter material is dependent on the size and power of the fan in use so as to promote effective airflow through the instrument case when closed and in operation.

Since this storage case will also dry and protect the instrument, the ventilated drying case provides the functions that overcome the drawbacks, shortcomings and problems of the standard musical instrument cases.

The size, quantity, voltage and amperage of the fans may vary depending on the instrument and case size and shape. However, most cases use two fans. One fan forces air into the case (intake port) and through the instrument and a second fan to blow air out of the case (exhaust port). The fans are typically 7-12 Volt; 0.04-1 amp electric fan mounted on the inside or outside of the instrument case forcing external air through the filter, into the case throughout the instrument and exits through the filtered exhaust port. This airflow will dry the inside and outside of the instrument as well as the case foam, protective felt and other storage case components. The intake and exhaust fans location and size vary depending on the instrument and fan, but effectively allow for the air to flow though an instrument before exiting the case.

The fan may contain a timer set to turn the motor on and off at predetermined intervals. This timer operation control unit may be made of a printed circuit board and an energy source management circuitry configured thereon and enclosed inside the case.

Although airflow would be significantly reduced, even when the fan is not operating airflow is continuous and eventually the instrument internal humidity will match the external humidity due to the multiple openings in the musical instrument case; thus allowing free flow of internal and external air passing through the charcoal filters and instrument.

All Brass and Wind instruments require performers to blow into the instrument to operate. This fills the instrument with saliva and even after swabbing an instrument residual saliva and dampness is left behind. Closing the standard case traps that moisture inside the instrument.

Ventilating the instrument and allowing a consistent filtered airflow inside the case maintains humidity consistent with that of the outside air. The filters reduce the gases in the air that come into contact with the instrument and tend to tarnish instruments unprotected.

Removing moisture from the inside of the instrument reduces oxidation and rust in the instrument and its components.

Removing moisture from the case reduces odors and mildew that can develop if left moist.

Other objects, features, and advantages of present invention will become apparent upon examining the following detailed description of an embodiment thereof, taken in conjunction with attached drawings.

### BRIEF DESCRIPTION OF DRAWINGS

These and other features aspects and advantages of the present invention will be better understood with regard to the following description, applied claims and accompanying drawings as follows:

FIG. 1A is a perspective view depicting an exemplary moisture drying and filtered air instrument storage case closed. The lid depicts the two fans which circulate the airflow. One fan faces into the case blowing air into the case, transversely the second fan faces outward and blows air from inside the case outward. The view also depicts the power source for the fans.

FIG. 1B is a perspective view of the fan assembly. The top layer is the cover that snaps over the mounting bracket. The second layer is the replaceable activated charcoal filter. The third layer is the mounting bracket which holds the fan on the inside of the case. The fourth layer is the lid of the case. The fifth layer is the fan. The diagram also shows the 4 bolts and 4 nuts which hold the mounting bracket and fan in place.

FIG. 1C is a perspective view depicting an exemplary moisture drying and filtered air instrument case having a lower custom-formed base for holding a woodwind instrument . The center section is protective foam that slips into the lid. There are cut out sections for the intake and exhaust fans to be recessed. The foam pad protects the instrument from touching the fan assemblies as well as holds the instrument into the lower base of the case. The holes in the foam allow are to flow into the case through the instrument and out the exhaust port. The lid depicts the two fans which circulate the airflow, as well as the power source and the electrical cables. One fan faces into the case blowing air into the case, transversely the second fan faces outward and blows air from inside the case outward.

FIG. 2 is a function diagram showing the salient components of the drying cases' operations control unit in operation with a fan and AC electric power source in accordance with one embodiment of the present invention.

FIG. 3 is a function diagram showing the salient components of the drying cases' operations control unit in operation with a fan and automobile power source in accordance with one embodiment of the present invention.

FIG. 4 is a function diagram showing the salient components of the drying cases' operations control unit in operation with a fan and battery electric power source in accordance with one embodiment of the present invention.

### DETAILED DESCRIPTION OF DRAWINGS

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art.

Used herein the terms “top” and “bottom” are intended to provide relative positions for the purpose of description, and are not intended to designate an absolute frame of reference of the invention, the order of blocks in diagrams representing one or more embodiments do not inherently represent any particular order nor imply any limitations of the invention.

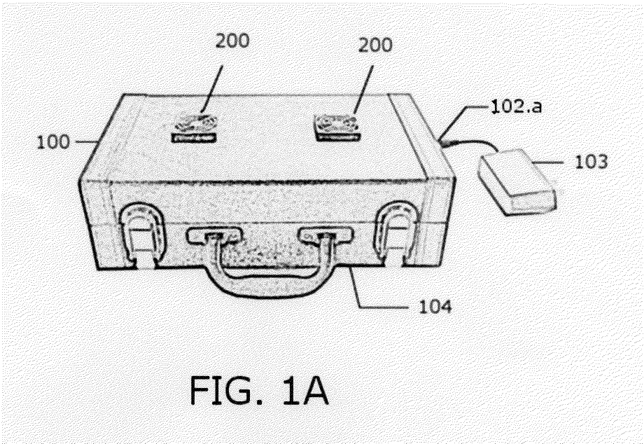

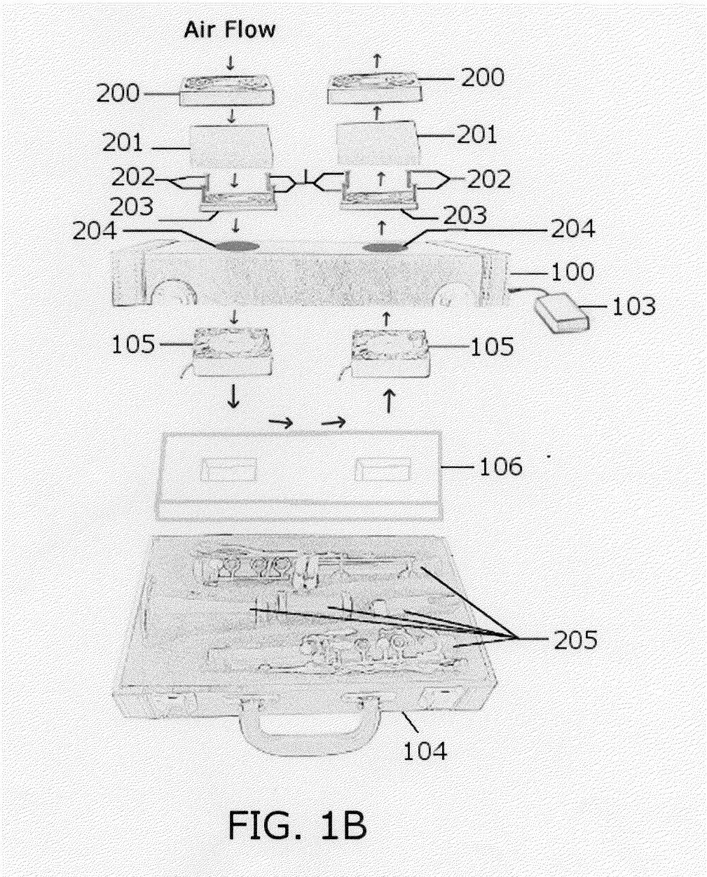

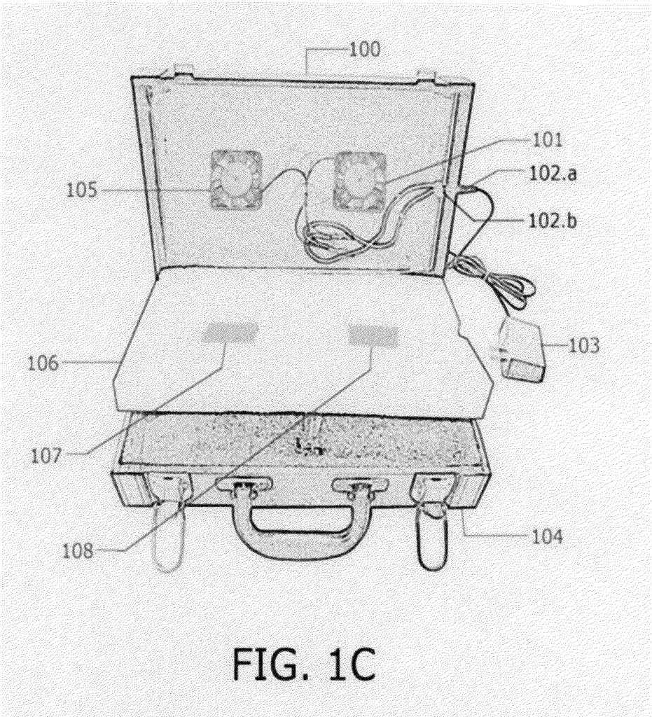

Embodiments of the present invention are discussed herein with reference to FIG. 1A-FIG. 4. However, those skilled in the art will readily understand and appreciate that the detailed description given herein with respect to these figures is for explanatory purposes as the invention extends beyond these limited embodiments.

Referring now to the drawings in which like numerals refer to like parts throughout the several views;

FIG. 1A is a perspective view depicting an exemplary moisture drying and filtered air instrument storage case closed: The lid depicts the two covers 200 over the intake and exhaust fans which circulate the airflow. One fan faces into the case blowing air into the case, transversely the second fan faces outward and blows air from inside the case outward. The view also depicts an AC power source. The AC power source is a 7-12 volt AC plug 103 with an electric wire running to a male 2.1 mm×5.5 mm DC power jack socket 102.a. This 7-12 volt power supply 103 with 2.1 mm×5.5 mm male connector 102.a may be disconnected from the case.

FIG. 1B is a perspective view of the fan assembly and airflow. The top piece 200 is the cover that snaps over the mounting bracket 203 and the filter 201. This cover 200 holds the filter 201 in place. The second piece 201 is the replaceable activated charcoal filter. The third piece is the mounting bracket 203 which holds the fan 101/105 on the inside of the case lid 100. The next section is the lid 100 of the case. The next section is the fan pair 101/105. The diagram also shows the 4 bolts 202 and 4 nuts which hold the mounting bracket 203 and fans 101/105 in place sandwiched with the lid 100 between. The next section down is the protective foam used to hold the instrument 205 in place when the lid 100 is closed. This foam 106 is glued inside the case lid 100. The bottom section is the base of the case 104 which holds the instrument 205.

An additional embodiment is shown in FIG. 1B. Airflow is depicted by the arrows. FIG. 1B depicts the airflow direction in from intake fan 105 into the case and through the instrument and out the exhaust fan 101 and exhaust port 204 while the fans are in operation. Additionally, when the fans are not in operation moisture will evaporate through both the intake 105 and exhaust fan 101 ports 204 causing the humidity to eventually match the humidity of the outside air. Air flows through the instrument 205 in the direction of the arrows when the lid is closed and the fan is in operation. When not in operation evaporation can occur through both ports 204 as well as depicted by additional arrows.

FIG. 1C is a perspective view depicting an exemplary moisture drying and filtered air instrument case having a lower custom-formed base 104 for holding a woodwind instrument.

The center section 106 is protective foam covered in black felt or other such decorative fabric that slips and is glued inside the upper lid 100. The foam pad protects the instrument from touching the fan assemblies as well as holds the instrument into the lower base 104 of the case. There are two cut our areas 107/108 in the foam pad for the intake 105 and exhaust 101 fans to be recessed. The holes are larger than the fans approximately 2 inches square, however the size of the holes 107/108 vary depending on the instrument, the size of the case and the size of the fans. The holes in the foam 107/108 allow air to flow into the case through the instrument and out the exhaust port 204.

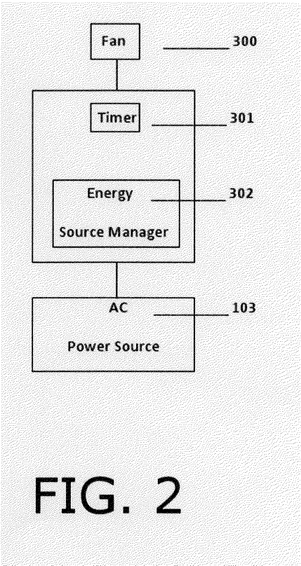

The lid 100 depicts the two fans which circulate the airflow, as well as the power source 103 and the electrical connection 102.a and 102.b. One fan 105 faces into the case blowing air into the case, transversely the second fan 101 faces outward and blows air from inside the case outward. The two fans are wired together to a 7-12 volt power source and may be controlled by a timer unit FIG. 2 to shut off after a predetermined time frame. The fans 101 and 105 vary in size voltage and amperage depending on the instrument and the instrument case size. They range from 7-12 Volt; 0.04-1 amp.

The AC power source is a 7-12 volt AC plug 103 with a electric wire running to a male 2.1 mm×5.5 mm DC power jack socket 102.a. This 7-12 volt power supply 103 with 2.1 mm×5.5 mm male connector 102.a may be disconnected from the case. Permanently mounted inside the case is a female 2.1 mm×5.5 mm panel mount connector 102.b. The size and position of the connectors 102.a and 102.b may vary depending on the size of the case, fan and type of instrument.

FIG. 2 is a function diagram showing the salient components of the drying cases' operations control unit 300 in operation with fans 101/105 and AC electric power source 103 in accordance with one embodiment of the present invention. The fan operations control unit 300 can be made of a printed circuit board with a timer 302 and an energy source manager 301 configured thereon. The timer 302 is configured for providing control to keep the fans 101/105 in operation for an adjustable and pre-determined length of time. The energy source manager 301 is configured to regulate the electric energy source 103 being used by the fan. The exemplary fan unit 101/105 can be found in a modern computer system as a cooling fan of electronic components.

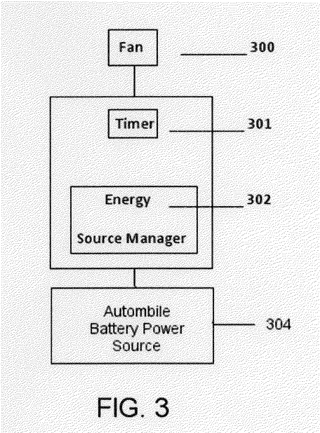

FIG. 3 is a function diagram showing the salient components of the drying cases' operations control unit 300 in operation with fans 101/105 and an automobile's battery power source 103 in accordance with one embodiment of the present invention. The fan operations control unit 300 can be made of a printed circuit board with a timer 302 and an energy source manager 301 configured thereon. The timer 302 is configured for providing control to keep the fans 101/105 in operation for an adjustable and pre-determined length of time. The energy source manager 301 is configured to regulate the electric energy source 103 being used by the fan. The exemplary fan unit 101/105 can be found in a modern computer system as a cooling fan of electronic components.

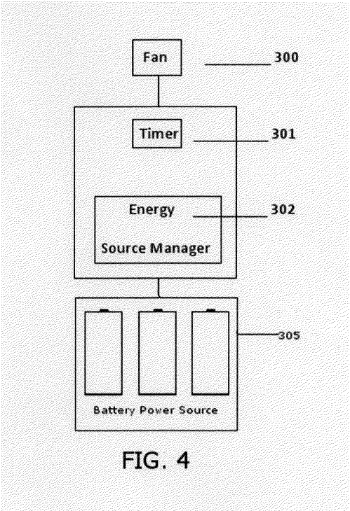

FIG. 4 is a function diagram showing the salient components of the drying cases' operations control unit 300 in operation with fans 101/105 and a battery power source 103 in accordance with one embodiment of the present invention. The fan operations control unit 300 can be made of a printed circuit board with a timer 302 and an energy source manager 301 configured thereon. The timer 302 is configured for providing control to keep the fans 101/105 in operation for an adjustable and pre-determined length of time. The energy source manager 301 is configured to regulate the electric energy source 103 being used by the fan. The exemplary fan unit 101/105 can be found in a modern computer system as a cooling fan of electronic components.

Although the present invention has been described with reference to specific embodiments thereof, these embodiments are merely illustrative, and not restrictive of the present invention. Various modifications or changes to the specifically disclosed exemplary embodiments will be suggested to a person skilled in the art. For example, whereas, a clarinet case has been shown and described, other instrument cases will work as well including all woodwind, and Brass instruments. Additionally, although we have shown and described one intake fan and one exhaust fan, multiple fans may be necessary to achieve optimal drying within an optimal time frame. Additionally, the location size, and power of the fans may be modified based on the instrument. Moreover, whereas the fan's operation control unit has been shown and described as a printed circuit board. Other equivalent control units can be used instead, for example an application specific integrated circuit. In summary, the scope of the invention should not be restricted to the specific exemplary embodiments disclosed herein, and all modifications that are readily suggested to those of ordinary skill in the art should be included within the spirit and purview of this application and the scope of the appended claims.

I claim:

1. A musical instrument moisture drying and ventilation case for removing moisture accumulated inside a woodwind and/or Brass musical instrument comprising:
a. A standard instrument carrying case designed to store and protect the instrument when not in use and during transport.
b. A fan unit including a fan or fans mounted on a motor and mounted inside the case blowing outside air inside the case through a filter. Additional fan(s) mounted on a motor and mounted inside the case blowing air from inside the case outward through a filter.

2. The musical instrument moisture drying and ventilating case referred to in 1, the filter system protects the instrument from tarnish and oxidation by utilizing activated charcoal to remove contaminants and impurities, utilizing chemical adsorption.

3. The musical instrument moisture drying and ventilating case referred to in 1, the filter system protects the instrument from harmful gasses in the air even when the fans are not in operation.

4. The musical instrument moisture drying and ventilating case referred to in 1, even when not in operation the case ventilates the instrument allowing the humidity to match that of the surrounding exterior environment.

5. The musical instrument moisture drying and ventilating case referred to in 1, the energy source comprises a power and operation control unit.

6. The musical instrument moisture drying and ventilating case operation control unit referred to in 5, further includes a duration timer to limit the fan operation to a preset length of time.

7. The musical instrument moisture drying and ventilating case operation control unit referred to in 5, further includes an energy source regulator.

8. The musical instrument moisture drying and ventilating case referred to in 1, the energy source comprises direct current electric power drawn from a wall outlet.

9. The musical instrument moisture drying and ventilating case referred to in 1, the energy source comprises direct current electric power drawn from an automobile's battery.

10. The musical instrument moisture drying and ventilating case referred to in 1, the energy source comprises direct current electric power drawn from one or more batteries.

11. The musical instrument moisture drying and ventilating case operation control unit referred to in 5, the power and control unit are dimensioned to be stored within the cavity space of case when not in use and for transport.

12. The musical instrument moisture drying and ventilating case referred to in 1, said electrical cable is configured to be removable from the case.

13. The musical instrument moisture drying and ventilating case referred to in 1, said electrical cable is configured to transmit electric power.

14. The musical instrument moisture drying and ventilating case referred to in 1, wherein the woodwind and brass musical instruments comprises one of but not limited to; trumpet saxophone, horn, French horn, cornet, flute, tuba, clarinet, oboe, bassoon, Baritone horn, English horn, flugelhorn and/or trombone.
a. ###
